(19) United States
(12) Patent Application Publication
(10) Pub. No.: US 2012/0202176 A1
(43) Pub. Date: Aug. 9, 2012

(54) OBJECTIVE MEASURE OF DRIVING PERFORMANCE

(75) Inventors: Timothy J. Dick, Dublin, OH (US); Kin Fung, Dublin, OH (US)

(73) Assignee: Honda Motor Co., Ltd., Tokyo (JP)

(21) Appl. No.: 13/023,323

(22) Filed: Feb. 8, 2011

(51) Int. Cl. G09B 19/16

(52) U.S. Cl. 434/65

(57) ABSTRACT

The embodiments describe vehicle system and method for evaluating driving performance of a driver of a vehicle. The vehicle system objectively evaluates a driver's performance using latitudinal and longitudinal acceleration to determine the smoothness in which the driver operates the vehicle.

### FIELD OF THE INVENTION

The embodiments discussed herein relates generally to evaluating driving performance of a driver of a vehicle, and more particularly to evaluating driving performance based on the smoothness in which the driver operates the vehicle.

### BACKGROUND

Driving performance (ability to drive) has been objectively measured in various ways by conventional systems. However, these conventional systems generally only take into account a single criterion with respect to driver input when determining driving performance of the driver.

For example, conventional systems have relied upon steering entropy to indicate driving performance of a driver (i.e., an operator) of a vehicle such as an automobile. Typically, a driver attempts to maintain safety margins when driving a vehicle such as staying within a given road lane. A violation of a safety margin is generally characterized by rapid corrective steering to maintain lane position. Conventional systems that rely upon steering entropy thus only account for a single dimension of the driver's inputs (i.e., steering control) to control the vehicle when evaluating the driving performance of the driver.

Conventional systems have also relied upon steering lane position to evaluate driving performance. These conventional systems determine an average lane position of a vehicle and determine the driver's driving performance based on the vehicle's deviation from an average lane position. Similarly, conventional systems have relied upon vehicle speed variation to evaluate driving performance. Thus, these conventional systems consider only a single criterion in terms of driver input when evaluating driving performance.

### SUMMARY

The embodiments provide a vehicle system and method for evaluating driving performance of a vehicle. Vehicle operation by a driver of the vehicle involves manipulating various vehicle controls such as the accelerator, brake pedal, and steering wheel. Manipulation of these vehicle controls results in the generation of forces due to acceleration, braking, and/or left or right cornering of the vehicle. The system measures the magnitude of the forces due to acceleration, braking, and left or right cornering of the vehicle thereby accounting for various driver inputs when evaluating driving performance.

In one embodiment, the system calculates a derivative of the magnitude of the forces to obtain the rate of change of the driving forces. The rate of change of the driving forces is indicative of the smoothness in which the driver operates the vehicle. Based on the smoothness of the operation of the vehicle, the system can evaluate the driving performance of the driver.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

FIG. 1 illustrates vehicle system according to one embodiment.

FIG. 2 illustrates a detailed view of a driving performance device according to one embodiment.

FIG. 3 illustrates a friction circle according to one embodiment.

FIGS. 4A and 4B illustrate graphs of driving performance according to one embodiment.

FIG. 5 illustrates a method for determining driving performance according to one embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

Embodiments are now described with reference to the figures where like reference numbers indicate identical or functionally similar elements. Also in the figures, the left most digits of each reference number corresponds to the figure in which the reference number is first used.

Reference in the specification to “one embodiment” or to “an embodiment” means that a particular feature, structure, or characteristic described in connection with the embodiments is included in at least one embodiment. The appearances of the phrase “in one embodiment” or “an embodiment” in various places in the specification are not necessarily all referring to the same embodiment.

Some portions of the detailed description that follows are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations or transformation of physical quantities or representations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “determining” or the like, refer to the action and processes of a computer system, or similar electronic computing device (such as a specific computing machine), that manipulates and transforms data represented as physical (electronic) quantities within the computer system memories or registers or other such information storage, transmission or display devices.

Certain aspects of the embodiments described herein include process steps and instructions described herein in the form of an algorithm. It should be noted that the process steps and instructions of the embodiments could be embodied in software, firmware or hardware, and when embodied in software, could be downloaded to reside on and be operated from different platforms used by a variety of operating systems. The embodiments can also be in a computer program product which can be executed on a computing system.

The embodiments also relates to an apparatus for performing the operations herein. This apparatus may be specially constructed for the purposes, e.g., a specific computer, or it may comprise a general-purpose computer selectively activated or reconfigured by a computer program stored in the computer. Such a computer program may be stored in a non-transitory computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Memory can include any of the above and/or other devices that can store information/data/programs. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the method steps. The structure for a variety of these systems will appear from the description below. In addition, the embodiments are not described with reference to any particular programming language. It will be appreciated that a variety of programming languages may be used to implement the teachings of the embodiments as described herein, and any references below to specific languages are provided for disclosure of enablement and best mode of the embodiments.

In addition, the language used in the specification has been principally selected for readability and instructional purposes, and may not have been selected to delineate or circumscribe the inventive subject matter. Accordingly, the disclosure of the embodiments is intended to be illustrative, but not limiting, of the scope of the embodiments, which is set forth in the claims.

### System Overview

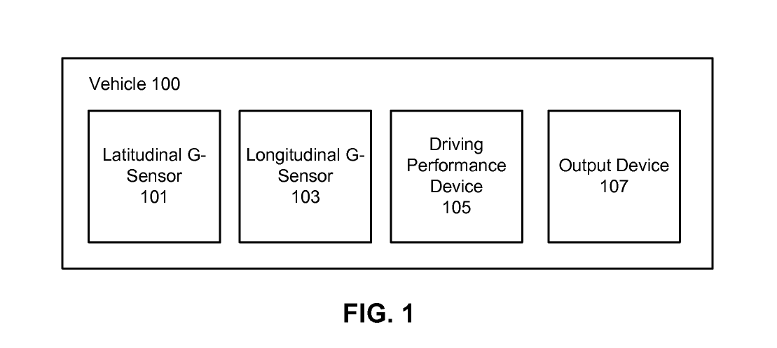

Referring now to FIG. 1, there is shown one embodiment of a vehicle 100. Note that in the embodiment of FIG. 1, the vehicle is described as an automobile, but may also represent other types of transportation means. Note that the vehicle 100 may include components other than those illustrated in FIG. 1 and further note that conventional components of a vehicle 100 such as the engine, tires, and suspension are omitted for brevity purposes.

Driving a vehicle 100 involves various control inputs from a driver to control the vehicle 100. Generally, the driving control inputs comprise modulation of the accelerator (i.e., gas pedal) to increase the speed of the vehicle, modulation of the brake pedal to decrease the speed of the vehicle 100, and steering inputs via a steering wheel to steer the vehicle 100. Each driver input causes an acceleration to occur in at least one of the longitudinal or latitudinal (i.e., lateral) directions. The resulting acceleration generates a corresponding driving force that is exerted by the vehicle 100. As will be described in detail below, the driving forces resulting from the various accelerations due to driver input are used to evaluate the driving performance of the driver of vehicle 100.

In one embodiment, the vehicle 100 comprises a latitudinal g-sensor 101 (e.g., an accelerometer). The latitudinal g-sensor 101 measures lateral acceleration as a result of a driver causing the vehicle 100 to turn in either the left or right direction. In other words, the latitudinal g-sensor 101 measures the acceleration created when the centrifugal force pushes the vehicle 100 sideways towards the outside of a turn while the vehicle 100 is turning.

The vehicle 100 also comprises a longitudinal g-sensor 103. The longitudinal g-sensor 103 measures longitudinal acceleration as a result of the vehicle accelerating or decelerating due to driver manipulation of the accelerator or brake pedal. For example, as the driver of the vehicle 100 presses on the accelerator, the vehicle accelerates causing an increase in longitudinal acceleration which is measured by the longitudinal g-sensor 103. Similarly, as the driver of the vehicle 100 presses the brake pedal or decreases the application of accelerator, the vehicle 100 decelerates causing a decrease in longitudinal acceleration which is measured by the longitudinal g-sensor 103.

In one embodiment, the vehicle 100 comprises a driving performance device 105. The driving performance device 105 determines driving performance based on the forces resulting from latitudinal and longitudinal acceleration information (data) respectively provided by the latitudinal g-sensor 101 and longitudinal g-sensor 103. Note that in alternative embodiments, sensors other than accelerometers may be used to measure acceleration data of the vehicle 100. In one embodiment, the driving performance device 105 determines the driver's driving performance based on the smoothness in which the driver operates the vehicle 100. As will be described in further detail below, the smoothness in which the driver operates the vehicle 100 is determined based on the latitudinal and longitudinal acceleration information.

The output device 107 represents any device equipped to output driving performance information to the driver of the vehicle 100. The output device 107 may be, for example, an organic light emitting diode display (OLED), liquid crystal display (LCD), cathode ray tube (CRT) display, or any other similarly equipped display device, screen or monitor. The output device 107 may be implemented in a heads up display, navigation system display, or any display system within the vehicle 100. In one embodiment, the output device 107 may also be equipped with a speaker that outputs audio from the driving performance device 105 or from various sources such as radio stations, compact disk, cassette, or MP3.

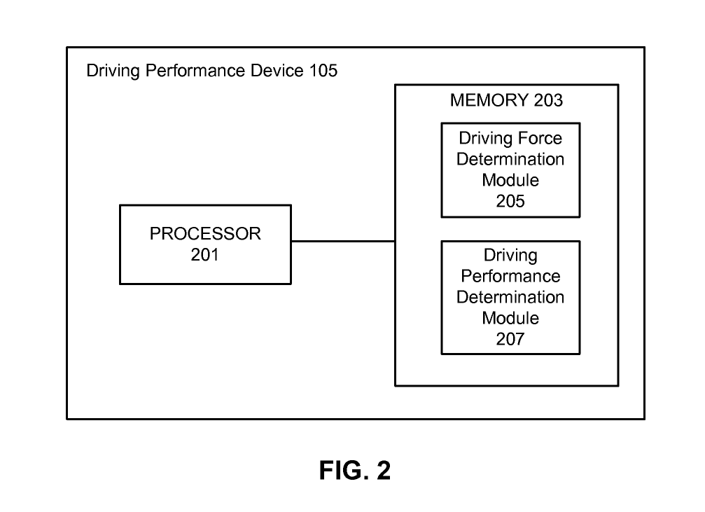

Referring now to FIG. 2, there is shown a detailed view of the driving performance device 105. The driving performance device comprises a computer processor 201 and a memory 203. Note that the driving performance device 105 comprises conventional features such as communication interfaces to the latitudinal g-sensor 101 and longitudinal g-sensor 103. However, the illustration of these conventional features has been omitted for brevity purposes. Note that in other embodiments, the driving performance device 105 may also comprise additional features other than those illustrated in FIG. 2.

In one embodiment, the processor 201 processes data signals and may comprise various computing architectures including a complex instruction set computer (CISC) architecture, a reduced instruction set computer (RISC) architecture, or an architecture implementing a combination of instruction sets. Although only a single processor is shown in FIG. 2, multiple processors may be included. The processor 201 may comprise an arithmetic logic unit, a microprocessor, a general purpose computer, or some other information appliance equipped to transmit, receive and process electronic data signals from the memory 203, latitudinal g-sensor 101, longitudinal g-sensor 103 and output device 107.

In one embodiment, the memory 203 stores instructions and/or data that may be executed by processor 201. The instructions and/or data may comprise code (i.e., modules) for performing any and/or all of the techniques described herein. Memory 203 may be any non-transitory computer-readable storage medium such as dynamic random access memory (DRAM) device, a static random access memory (SRAM) device, Flash RAM (non-volatile storage), combinations of the above, or some other memory device known in the art.

In one embodiment, the memory 203 comprises a driving force determination module 205 and a driving performance determination module 207. Note that in other embodiments, other modules than those shown in FIG. 2 may be used to perform the functionality described herein. The modules are adapted to communicate with the processor 201, latitudinal g-sensor 101, longitudinal g-sensor 103, and output device 107.

In one embodiment, the driving force determination module 205 measures magnitudes of driving forces. As previously described above, driving a vehicle 100 involves various control inputs from a driver to control the vehicle 100. The driving force determination module 205 receives acceleration information from the latitudinal g-sensor 101 and longitudinal g-sensor 103 as the driver provides the control inputs to operate vehicle 100. As the vehicle 100 is being operated by the driver, the driving force determination module 205 calculates the magnitude of the driving forces with respect to time based on the acceleration information received from the latitudinal-g sensor 101 and longitudinal g-sensor 103.

For example, during vehicle operation, the latitudinal-g sensor 101 and longitudinal g-sensor 103 may provide acceleration information at a rate of 100 readings per second where each reading may be associated with a time stamp indicative of the time of the reading. Accordingly, the driving force determination module 205 calculates for each time reading, the magnitude of the forces due to the acceleration in the latitudinal axis and longitudinal axis. The calculation of the magnitude of the forces for each reading results in a set of driving forces representative of the magnitudes of the forces during the duration of the trip in the vehicle 100. In one embodiment, the set represents a single trip characterized by when the driver starts the vehicle 100 to when the driver turns off the vehicle 100.

In response to receiving the acceleration information, the driving force determination module 205 calculates a force vector that is representative of the magnitude of the combination of the forces due to acceleration, braking, and left or right cornering for a given instance in time. In one embodiment, the driving force determination module 205 calculates the magnitude of the driving forces for a particular time based on the following equation:

DrivingForce(t)={square root over ((LatG(t))²+(LongG(t))²)}

In the equation shown above, the magnitude of the driving force (DrivingForce(t)) represents the combination of the forces due to acceleration, braking, and left or right cornering for a given instance in time t. The driving force determination module 205 receives from the latitudinal g-sensor 101 and longitudinal g-sensor 103 latitudinal acceleration data and longitudinal acceleration data for instances in time. To determine the magnitude of the driving for a given instance in time, the driving force determination module 205 squares the sum of the latitudinal acceleration data (LatG) at time t raised to the second power and the longitudinal acceleration data (LongG) at time t raised to the second power.

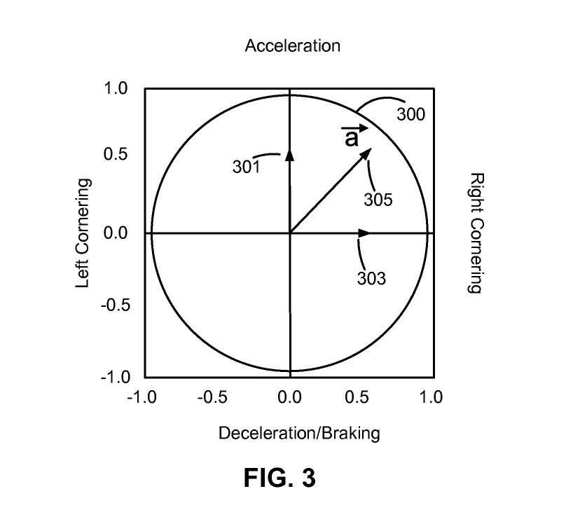

Referring now to FIG. 3, there is shown a friction circle 300 illustrating an example of the forces due to acceleration in the latitudinal and longitudinal directions in response to the driver operating vehicle 100. The boundary 300 of the friction circle represents the maximum amount of force that may be exerted by the vehicle 100 before loss of grip or fraction occurs. In one embodiment, the horizontal axis of the friction circle 300 represents force in the latitudinal direction whereas the vertical axis of the friction circle 300 represents force in the longitudinal direction. The forces of the friction circle are measured in g-force according to one embodiment. The uppermost data point in the longitudinal axis (e.g., 1.0 G) represents the maximum g-force created by full acceleration of the vehicle 100 in a straight line. The bottom most data point in the longitudinal axis (−1.0 G) represents the maximum g-force created by full braking of the vehicle in a straight line. The leftmost and right most data point in the latitudinal axis represents the maximum cornering forces the vehicle 100 can achieve in the left or right direction.

In this example, the friction circle illustrates that the vehicle 100 is experiencing a positive g-force in the longitudinal axis as indicated by the direction of arrow 301. Thus, the vehicle 100 is accelerating. The length of arrow 301 represents the magnitude of the longitudinal g-force of vehicle 100. Similarly, the direction of arrow 303 indicates that the vehicle 100 is turning right and the length of arrow 303 represents the magnitude of the latitudinal g-force of vehicle 100.

Arrow 305 is representative of the magnitude of the longitudinal and latitudinal g-forces of vehicle 100. Specifically, the length of arrow 305 represents the magnitude of the longitudinal g-force 301 and latitudinal g-force 303 of the vehicle 100. The direction of arrow 305 indicates that the magnitude is positive and to the right indicative of the vehicle accelerating to the right.

Referring back to FIG. 2, in one embodiment, the driving performance determination module 207 determines the driving performance of the driver based the smoothness in which the driver operates the vehicle 100. The driving performance determination module 207 determines the smoothness of the operation of the vehicle 100 by determining the rate of change of the magnitude of the driving forces with respect to time. The rate of change is indicative of the smoothness of operation of the vehicle 100.

The driving performance determination module 207 determines the rate of change according to the following equation:

$$Smoothness ( t ) = \frac{d}{d t} DrivingForce ( t )$$

As shown above equation, the driving performance determination module 207 calculates the smoothness in which the driver operates the vehicle 100 by taking the derivative of the driving force with respect to time. The driving performance determination module 207 calculates the smoothness real time in response to the driving force determination module 207's calculation of the driving forces while the driver is operating vehicle 100. That is, in response to the driving force determination module 207 calculating a driving force for a given time t, the driving performance determination module 207 calculates the rate of change of driving force for time t.

The driving performance determination module 207 compares the calculated rate of change (i.e., smoothness) to a default driving performance to evaluate the driver's driving performance. In one embodiment, the default driving performance is representative of typical driving performance exhibited by the driver of vehicle 100. That is, the default driving performance describes how well the driver usually operates the vehicle 100. In one embodiment, the default driving performance may represent the average driving performance of the driver for some duration of time. For example, driving performance determination module 207 may calculate the average driving performance of the driver over an hour, day, week, or month of driving the vehicle 100 and establish the average driving performance as the default driving performance.

In one embodiment, the default driving performance may also be trip specific. For example, for the first “x” minutes of the trip in vehicle 100, the driving performance determination module 207 may calculate the smoothness of the driver's operation of the vehicle 100 during those “x” minutes of the trip. The driving performance determination module 207 establishes the calculated smoothness as the default driving performance for the trip.

In one embodiment, at predetermined time intervals during a trip in the vehicle 100, the driving performance determination module 207 compares the smoothness of driver operation over a duration of time of the trip to the default driving performance in order to evaluate the driving performance of the driver. For example, after every minute of the driver operating vehicle 100, the driving performance determination module 207 may compare the smoothness of driver operation for the previous minute of driving to the default driving performance in order to evaluate the driving performance of the driver. Alternatively, the driving performance determination module 207 may compare the smoothness of driver operation during a previous interval of time (e.g., previous “x” minutes) with the smoothness of driver operation during a most recent interval of time (e.g., the most recent “x” minutes).

In response to the smoothness for the duration being within a threshold value of the default driving performance, the driving performance determination module 207 determines that the driver is operating the vehicle 100 in a typical fashion. In one embodiment, the smoothness of the driver performance being within the threshold in indicative that the driver is fully attentive while driving the vehicle 100. However, if the driving performance for the duration exceeds the threshold value, the driving performance determination module 207 identifies an anomaly in the driving performance of the driver. In other words, the driving performance determination module 207 determines that the driver is operating the vehicle 100 in an unusual manner indicative of possible driver fatigue.

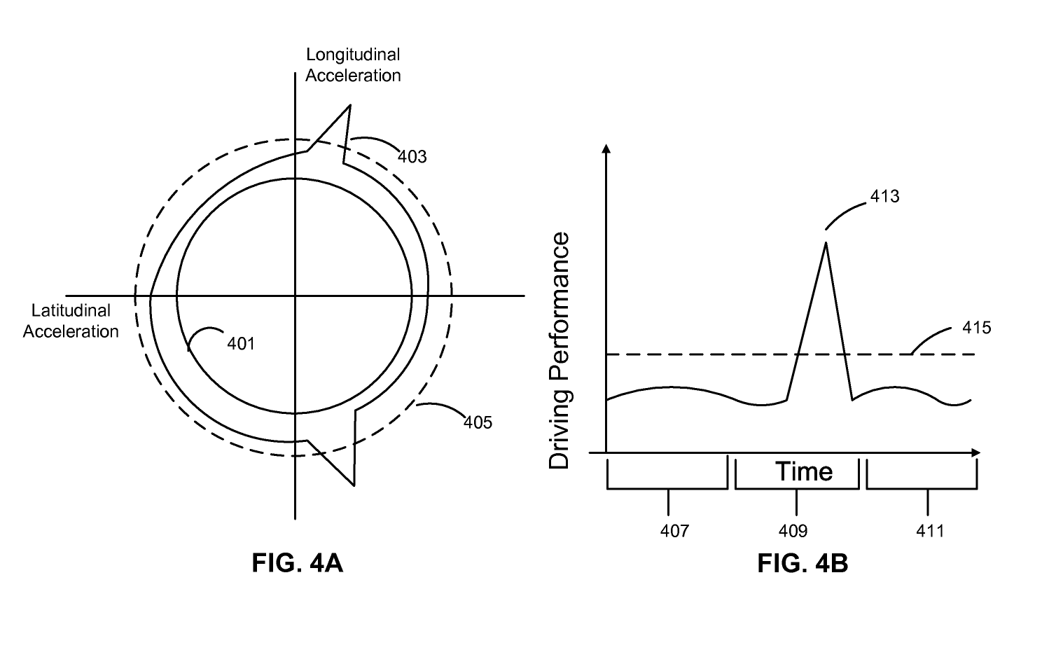

Referring now to FIG. 4A, a default driving performance plot 401 and a current driving performance plot 403 are shown. The default driving performance plot 401 illustrates the magnitudes of the driving forces representative of the default driving performance. The current driving performance plot 403 illustrates the magnitudes of the driving forces during a current trip in vehicle 100. Additionally, FIG. 4A comprises a threshold plot 405 indicative of the threshold value that the current driving performance plot 403 may deviate from the default driving performance plot 401. The threshold plot 405 may be based on the previous driving performance of the driver in one embodiment. Alternatively, the threshold plot 405 may be based on a general population of drivers or may be a predefined threshold.

As shown in FIG. 4A, the default driving performance plot 401 illustrates a constant rate of change of the driving forces exhibited by the circularity of the plot 401. In contrast, the current driving performance plot 401 exhibits inconsistent rates of change of the driving forces during the trip illustrated by the irregular shape of plot 403. Particularly, spike 403 exceeds the threshold plot 405. Thus, the rate of change of the driving forces during the current trip exceeds the threshold thereby indicating an anomaly in the driver's performance. For example, the spike 403 may be indicative of the vehicle 100 swerving due to fatigue.

Referring now to FIG. 4B, a graph of driving performance over time is shown. The graph is divided into three time intervals: time interval 407, time interval 409, and time interval 411. Dashed line represents a threshold value 415 of driving performance until an anomaly in the driver's driving performance is exhibited. The threshold value may be specific to the driver in one embodiment or may be based on a general population of drivers. Alternatively, the threshold value may be predefined. As shown in FIG. 4B, the driving performance within time intervals 407 and 411 are below the threshold value 415. However, during time interval 409 the driving performance exceeds the threshold value represented by spike 413. Similar to FIG. 4A, the spike 413 may be indicative of the vehicle 100 swerving.

Referring back to FIG. 2, responsive to exceeding the threshold value, in one embodiment the driving performance determination module 207 may communicate with the output device 107 to output a communication directed to the driver of the vehicle 100. The communication may alert the driver of vehicle 100 of the driver's current driving performance. For example, the driving performance determination module 207 may cause the output device 107 to output a visual and/or audio signal for the driver to pull over due to his or her poor driving performance or an indication of abnormal driving performance.

In one embodiment, the driving performance determination module 207 may update the default driving performance periodically so that the default driving performance is kept current. For example, the driving performance determination module 207 may update the default driving performance on a daily, weekly, or monthly basis.

The driving performance determination module 207 may also update the default driving performance during the trip. The driving performance determination module 207 may identify that the driver is consistently operating the vehicle 100 in a manner that deviates from the default driving performance. Accordingly, the driving performance determination module 207 may update the default driving performance to represent the current driving performance of the driver 100.

For example, the driving performance determination module 207 may initially determine the default driving performance when the driver is operating the vehicle 100 on a straight road. However, the driving performance determination module 207 may identify driving performance indicative of swerving conditions due to the vehicle 100 being driving on a curvy road. The current default driving performance cannot be accurately used to measure driving performance. Accordingly, the driving performance determination module 107 updates the default driving performance to be consistent with the driver's current operation of the vehicle 100.

### Driving Performance Determination Method

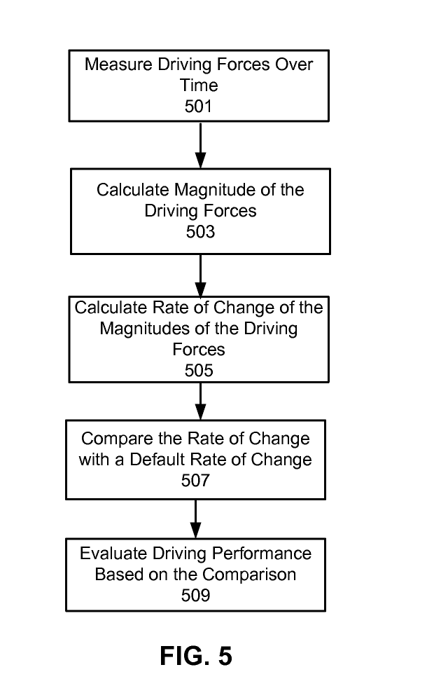

Referring now to FIG. 5, there is shown one embodiment for a method for determining driving performance. Note that in other embodiments, other steps may be performed than those illustrated in FIG. 5.

In one embodiment, the driving performance device 105 measures 501 driving forces over time. To measure the driving forces, the driving performance device 105 receives latitudinal acceleration information from the latitudinal g-sensor 101 and longitudinal acceleration information from the longitudinal g-sensor 103 during the duration of a trip in the vehicle 100. The raw acceleration information from the latitudinal g-sensor 101 and longitudinal g-sensor 103 are processed by the driving performance device 105 to remove noise caused by the chassis and road. The driving performance device 105 also removes high frequency signals that could not originate from the driver's input. From the acceleration information, the driving performance device calculates 503 the magnitude of the driving forces as the driver is operating the vehicle 100.

The driving performance device 105 then calculates 505 real-time the rate of change of the magnitude of the driving forces by taking the derivative of the driving forces with respect to time. The driving performance device 105 compares 507 the rate of change of the magnitude of the driving forces with a default rate of change 507. Based on the comparison, the driving performance device 105 evaluates 509 the driving performance of the driver. In response to the driving performance being indicative of abnormal driving behavior being exhibited by the driver, the output device 107 may indicate to the driver of the vehicle 100 the abnormal driving behavior.

While particular embodiments and applications of the embodiments have been illustrated and described herein, it is to be understood that the embodiments are not limited to the precise construction and components disclosed herein and that various modifications, changes, and variations may be made in the arrangement, operation, and details of the methods and apparatuses of the embodiments of the present disclosure without departing from the spirit and scope of the disclosure as it is defined in the appended claims.

What is claimed is:

1. A computer-implemented method for determining driving performance for a driver operating a vehicle, the method comprising:
measuring driving forces that are exerted due to acceleration of the vehicle;
calculating a magnitude of the driving forces;
calculating a rate in which the magnitude of the driving forces changes over time;
comparing the calculated rate to a default rate of change of driving forces, the default rate of change indicative of typical driving performance of the driver of the vehicle; and
evaluating driving performance of the driver of the vehicle based on the comparison.

2. The computer-implemented method of claim 1, further comprising:
receiving real-time acceleration information describing the acceleration of the vehicle; and
measuring the driving forces based on the real-time acceleration information responsive to receiving the real-time acceleration information.

3. The computer-implemented method of claim 2, wherein receiving the real-time acceleration information comprises:
receiving latitudinal acceleration information that describes cornering information of the vehicle; and
receiving longitudinal acceleration information that describes acceleration and deceleration information of the vehicle.

4. The computer-implemented method of claim 1, wherein calculating the magnitude of the driving forces comprises calculating the magnitude according to the following equation:
DrivingForce(t)={square root over ((LatG(t))²+(LongG(t))²)};
where:
t is time;
DrivingForce(t) is the magnitude of the driving forces at time t;
LatG(t) is lateral acceleration of the vehicle at time t; and
LongG(t) is longitudinal acceleration of the vehicle at time t.

5. The computer-implemented method of claim 4, wherein calculating the rate in which the magnitude of the driving forces changes over time comprises:
calculating a derivative of the magnitude of the driving forces with respect to time, the derivative of the magnitude indicative of a smoothness in which the driver operates the vehicle.

6. The computer-implemented method of claim 1, wherein calculating the default rate of change comprises:
calculating the default rate of change of driving forces during a defined duration of driver operation of the vehicle.

7. The computer-implemented method of claim 6, wherein the duration comprises a week of the driver driving the vehicle.

8. The computer-implemented method of claim 6, wherein the duration comprises a day of the driver driving the vehicle.

9. The computer-implemented method of claim 1, wherein comparing the calculated rate to a default rate of change of driving forces comprises:
comparing the calculated rate to the default rate at a predefined time interval during operation of the vehicle by the driver.

10. The computer-implemented method of claim 1, further comprising:
updating the default rate of change of driving forces to reflect current driving performance of the driver.

11. The computer-implemented method of claim 1, wherein evaluating the driving performance of the driver of the vehicle based on the comparison comprises:
determining whether the calculated rate exceeds a threshold value from the default rate of change of driving forces; and
responsive to the calculated rate exceeding the threshold indicative of an anomaly in the driving performance of the driver, outputting an indication to the driver of the anomaly.

12. A non-transitory computer-readable storage medium storing executable code for determining driving performance for a driver operating a vehicle, the code when executed performs the steps comprising:
measuring driving forces that are exerted due to acceleration of the vehicle;
calculating a magnitude of the driving forces;
calculating a rate in which the magnitude of the driving forces changes over time;
comparing the calculated rate to a default rate of change of driving forces, the default rate of change indicative of typical driving performance of the driver of the vehicle; and
evaluating driving performance of the driver of the vehicle based on the comparison.

13. The non-transitory computer-readable storage medium of claim 12, the code when executed further performs the steps comprising:
receiving real-time acceleration information describing the acceleration of the vehicle; and
measuring the driving forces based on the real-time acceleration information responsive to receiving the real-time acceleration information.

14. The non-transitory computer-readable storage medium of claim 12, wherein calculating the magnitude of the driving forces comprises calculating the magnitude according to the following equation:
DrivingForce(t)={square root over ((LatG(t))²+(LongG(t))²)};
where:
t is time;
DrivingForce(t) is the magnitude of the driving forces at time t;
LatG(t) is lateral acceleration of the vehicle at time t; and
LongG(t) is longitudinal acceleration of the vehicle at time t.

15. The non-transitory computer-readable storage medium of claim 14, wherein calculating the rate in which the magnitude of the driving forces changes over time comprises:
calculating a derivative of the magnitude of the driving forces with respect to time, the derivative of the magnitude indicative of a smoothness in which the driver operates the vehicle.

16. The non-transitory computer-readable storage medium of claim 12, wherein evaluating the driving performance of the driver of the vehicle based on the comparison comprises:
determining whether the calculated rate exceeds a threshold value from the default rate of change of driving forces; and
responsive to the calculated rate exceeding the threshold indicative of an anomaly in the driving performance of the driver, outputting an indication to the driver of the anomaly.

17. A vehicle system for determining driving performance for a driver operating a vehicle, the system comprising:
a computer processor; and
a computer-readable storage medium storing executable code when executed by the computer processor performs the steps comprising:
measuring driving forces that are exerted due to acceleration of the vehicle;
calculating a magnitude of the driving forces;
calculating a rate in which the magnitude of the driving forces changes over time;
comparing the calculated rate to a default rate of change of driving forces, the default rate of change indicative of typical driving performance of the driver of the vehicle; and
evaluating driving performance of the driver of the vehicle based on the comparison.

18. The vehicle system of claim 17, the code when executed by the computer processor further performs the steps comprising:
receiving real-time acceleration information describing the acceleration of the vehicle; and
measuring the driving forces based on the real-time acceleration information responsive to receiving the real-time acceleration information.

19. The vehicle system of claim 17, wherein calculating the magnitude of the driving forces comprises calculating the magnitude according to the following equation:
DrivingForce(t)={square root over ((LatG(t))²+(LongG(t))²)};
where:
t is time;
DrivingForce(t) is the magnitude of the driving forces at time t;
LatG(t) is lateral acceleration of the vehicle at time t; and
LongG(t) is longitudinal acceleration of the vehicle at time t.

20. The vehicle system of claim 19, wherein calculating the rate in which the magnitude of the driving forces changes over time comprises:
calculating a derivative of the magnitude of the driving forces with respect to time, the derivative of the magnitude indicative of a smoothness in which the driver operates the vehicle.
